(19) United States
(12) Patent Application Publication
(10) Pub. No.: US 2023/0257529 A1
(43) Pub. Date: Aug. 17, 2023

(54) Sargasso mats and Sargasso sheets for insulation on other purposes and its low-tech formation processes

(71) Applicant: Pablo Emilio Luzuriaga, Plantation, FL (US)

(72) Inventor: Pablo Emilio Luzuriaga, Plantation, FL (US)

(21) Appl. No.: 17/670,472

(22) Filed: Feb. 13, 2022

(51) Int. Cl. C08H 8/00; B65D 65/38; B32B 9/02; B32B 9/04; B01D 39/16; A42B 1/019; C08J 5/18; G10K 11/168

(52) U.S. Cl. CPC C08H 8/00; A42B 1/019; B01D 39/1615; B32B 9/02; B32B 9/04; B32B 9/045; B65D 65/38; C08J 5/18; G10K 11/168; C08J 2397/02

(57) ABSTRACT

Pelagic Sargasso seaweed masses floods Caribbean Islands and Gulf of Mexico shores. Eighty percent of those masses are water, and out of the water those masses rot fast. There was not a profitable use for them until now. Sargasso is collected, compressed and dried by the air in thin sheets or mats, locally in a low- tech process. Once the sheets and mats are dried, they are stable and light. They have many uses such as thermal and sound barriers, sound absorbers, shock absorbers, air filters, etc.

### CROSS-REFERENCE TO RELATED APPLICATIONS

This application claims the benefit of provisional patent application 63/200,199 filled 2021 February 20,

### PRIOR ART

The following is a tabulation of some prior art that presently appears relevant.

### Foreign Patent

Patent number CN 105133415B Environmentally friendly marine organism base flame retardation paper and production method thereof. Filled 2015 July 9 by DONGLANGOKE

### Nonpatent Literature Online Documents

Golden Tides: Problem or Golden Opportunity? The Valorization of Sargassum from Beach Innundations. By John J. Milledge and Patricia J. Harvey. Journal of Marine Science Engineering.

John Ehrisman in his “STUDY ON THE PROCESSING CHARACTERISTICS AND REINFORCING POTENTIAL OF NATURAL FIBERS”

Sargacreto to the new construction material made of sargassum at www.theucatantimes.com

### BACKGROUND

Human use of resources seems unstoppable, the demand increases instead of reducing. As a result, we are not even close to stop global warming. We have to come up with new green technologies for these times. Sargasso mats and sheets not only take care of the nuisance of Sargasso on the shores but provide a new construction material for industries to use.

There are two kinds of Sargasso: benthic Sargasso that grows below the sea level and attached to seabed, and pelagic Sargasso that grows freely floating in the Atlantic. Millions and millions of tons of Sargasso are washed to beaches, where the main income for those shores is tourism. The flood of smelling Sargasso ruins tourism. There are extensive research and attempts to use that Sargasso. They are summarized in the Journal of Marine Science Engineering an article called “Golden Tides: Problem or Golden Opportunity. The Valorization of Sargassum from Beach Inundations” By John J. Milledge and Patricia J. Harvey. The article covers many distinctive chemical composition and potential in many industries but, at the same time, states that none of them are economically viable. The conclusion in the last page states: “More research is needed to characterize golden tides and to identify and develop commercial products and process”.

There are three obstacles that prevents the use the Sargasso in the industry:

1. Scattered distribution: Sargasso floods seasonally in the Caribbean Islands and beaches of warm weather countries with Atlantic shores in South, Central and North America. Sargasso nowadays is a nuisance, and the coastal cities affected by it are trying to find a use for it. Transporting the Sargasso masses from distant beaches to a central processing plant is expensive.

2. High water content: Eighty percent of Sargasso mass is made of water. It is unreasonable to transport tons of Sargasso masses for long distances to later lose eighty percent of its mass as vapor. It is not viable for shipping and drying costs.

3. Fast decomposition: Sargasso masses start to smell fast on the beach, meaning that they are decomposing. By the time they reach a process plan they convert in compost.

Summarizing the attempts, researchers have tried using those masses as biofuel but in order to dry the Sargasso, energy was needed and when dried, it produced very low thermal values due to the high ash content. It has also been used to feed animals, but its high Sulphur content limits its use.

There is a pending patent in Mexico that uses the Sargasso as a structural material to create bricks, blocks and a concrete mix. I couldn’t get access to the specifications. Their process and the final product are different. They do not produce sheets and mats and the final product is called Sargacreto, a mix of Sargasso and concrete for lightweight uses. My products disclosed here are mats and sheets made of Sargasso. They have many purposes and one of them is to use them as insulator barriers.

Fiberglass is the most popular insulation barrier but has formaldehyde that people breathe making it contaminant and not efficient. The only reason why seventy percent of new houses still use it is because of its price. Sargasso mats are much better thermal barriers.

Evaluating Sargasso from different points of view, such as economical, ecological, social and energy costs and also the quality of the final product, it is suitable to bring Sargasso to the industry. I will disclose the characteristic, benefits, and ways to use it.

### SUMMARY

Many Caribbean, Gulf of Mexico and Florida beaches become flooded with pelagic Sargasso Coastal cities need to collect it, in order to keep tourism thriving. Since eighty percent of that seaweed mass is water, shipping it becomes expensive and there is not a use for it. In accordance with one embodiment, where masses of fresh Pelagic Sargasso reach a shore, they are collected and processed locally by compressing and drying them, so they become tangled, interlocked and bonded creating sheets and mats of Sargasso with uses such as: thermal barrier, sound absorber, AC filters, shock absorbers.

### DESCRIPTION

So far, all existent attempts to successfully use Sargasso are hindered by these three obstacles mentioned above.

A felt is a cloth made of animal fibers such as wool and fur through the action of heat, moisture, and pressure. It is a very similar process when forming a mat. But mat is used for vegetal fibers. Since I use seaweed as a fiber and a similar process. I use the term Sargasso mats. I also use the term of Sargasso sheets, and this is in regard of the thickness and cohesion of the product.

Sargasso mats and sheets do not have any unique standard size. I will disclose a process to produce mats and other process to produce sheets, some different uses for those mats and sheets and also how they can be further processed to create new products and uses. Sargasso mats and sheets although simple, surpass the three obstacles of scattered distribution, high water content and fast decomposing.

### Sargasso Cycle

### 1. Sargasso Sea

There is always Sargasso floating in the Sargasso Sea located North of Bermuda. This Sargasso is a wild sanctuary providing places to nest, hiding and food for fishes, eels, turtles, etc. It also absorbs Carbon Dioxide from the water and oxygenates it. The South Atlantic Fishery Management Council phaseout all harvest from this area since 2002. This Sargasso is not to be touched.

### 2. Sargasso Traveling in the Atlantic Gyre

There is also seasonal Sargasso travelling in the Atlantic Gyre that, when it crosses the Atlantic and reaches the Lesser Antilles, this Sargasso blooms. Some of it keeps traveling in the Atlantic Gyre and some is tossed to the beaches.

### 3.Sargasso Tossed to the Shores

Some Sargasso traveling in the Atlantic Gyre is pushed by the waves and tossed to the beaches depending on the wind and currents. This is the lysis phase of the Sargasso and instead of cleaning the oceans, contaminates them because the Sargasso is pounded by the waves, loses the air bladders, sinks in the water and decomposes. Some of this Sargasso instead of sinking, gets tossed over the beach in the sand. Some coastal cities bury this Sargasso on the sand, but a few weeks later the rain infiltrates the sand, and all the nutrients end on the shallow seawater. The effect is that the seawater close to the beaches in South Florida is highly contaminated. Bacteria blooms in this rich warm water filled with nutrients and becomes a hazard for beachgoers. So, Sargasso should be removed from the beaches or prevented to reach the beaches. Some coastal cities install meshes on the waters that block Sargasso to reach the beaches. Some cities spend a lot of money to keep beaches clean and safe. If there were a use for this Sargasso, at least cities would be able to get some money back.

What happens when Sargasso reaches the beaches without human involvement

Pelagic Sargasso per se is not a good insulator. Depending in the quantity of Sargasso flooding the beach and the intensity of the sun, different things happen. When fresh wet Sargasso floods the beaches, the Sargasso piles up, does not dry and becomes rot and smelling. By contrast, when a small amount of Sargasso arrives to the beaches, the sun dries it, the seaweed becomes rigid keeping a 3D structure with a lot of spaces between the rigid small branches that allows the circulation of air, making it not a good insulator in this stage.

### Sargasso Mats and Sheets

The masses of fresh Pelagic Sargasso reaching a shore are collected and processed locally by compressing and drying them, so they become tangled, interlocked and bonded, creating sheets and mats of Sargasso with uses such as: thermal barrier, sound absorber, AC filters, shock absorbers.

Fresh pelagic Sargasso out of the sea degrade fast. In order to find a use to that Sargasso I am disclosing the layout of two similar processes, through compressing it, create thin sheets and thin mats. The wind goes over the surfaces of sheets and mats drying them. At the end of the process the Sargasso masses have converted in a stable, light, odorless sheets and mats of Sargasso with many useful purposes.

Those two processes are low-tech so all Sargasso reaching a shore can be used sequestering Carbone from the oceans. Which one is best depends on the local shore conditions, and local resources. Sometimes the same place can be using both processes. If there is a rainy forecast, the first process is used where Sargasso is under a roof.

The mats and sheets properties will be given by the Sargasso properties.

### Pelagic Sargasso Analysis of Organic Compounds and Properties

Sargasso is a seaweed, and its structure and components are totally different from a terrestrial plant. That gives Sargasso other properties that made it suitable for using them as insulation barriers.

### Sargasso as Fire Retardant

When producing insulating panels with other natural fibers such hemp, paper; fire retardant compounds are added. It is an extra cost and brings toxicity to the house. Sargasso, on the other hand does not burn well. The heating values are less than of the terrestrial energy crops due to the high ash content and the lack of cellulose and lignin.

Moreover, when Sargasso is assembled in a mat, the lack of Oxygen and the possible presence of sand makes it harder to catch a fire.

Most of terrestrial plants are composed by walls of cellulose. Sargasso walls are made of other polysaccharide such as laminarin, mannitol, alginate, fucan and few traces of cellulose. It is difficult to burn Sargasso because it does not produce flames. See patent: CN 105133415B Environmentally friendly marine organism base flame retardation paper and production method thereof.

### Sargasso as Insect and Mold Resistant

Sargasso also has been experimented to feed cows, but it has many Sulphur compounds that makes it hard to digest and it is toxic in excess. Fucan, one of the polysaccharides cited above, is sulphated nontoxic and inhibits virus and parasite invasion. Sargasso has a lot of phenolic compounds that are considered a chemical defense against grazers, bacteria, fungi. Sargasso has one point four percent Sulphur content. Those compounds repel mold and insects so Sargasso even though it is not a heavy fiber, it is a very tough material.

### Cost of Producing the Fiber

All other plants need water, soil, fertilizer, production cost, short period of harvesting, etc. so comparing it with other fiber plant production, Sargasso is free and there are tons everywhere. Coastal cities pay landfills to receive the Sargasso. So, the collection and shipping from the beach should be free too.

### No Tissue Differentiation

The seaweed structure is simpler than a vascular plant. Seaweed does not have differentiated tissues as fibers and conducts. They are just a small branched multicellular mass with tiny blades and gas filled bladder. Basically, this is all its structure. When using other plants as cotton, hemp, or linen, only a small fraction of the harvest will become the new raw fiber. However, with Sargasso, all of it is used as a raw material.

### No Rigidity- No Resilience- No Brittleness

Sargasso floats in the seawater and does not need rigid walls of cellulose. Forty percent of its dried weight is composed of alginates, a jelly substance that has many uses in the industry. And gives elasticity to the seaweed to adapt to the wave’s forces. So, when seaweed is flattened against a hard surface creates a sheet and when is compressed inside a mold, it does not offer any resistance to adapt perfectly to the mold shape creating an airtight mat.

No resilience: Resilience is the capability of a stained body to recover its size and shape after deformation caused especially by compressive stress. Once the fresh Sargasso masses are compressed and dried with a relative low weight, they don’t have resilience, they become semirigid in that position and all the parts of the mass get interlocked and bonded together, creating a Sargasso mat or a Sargasso sheet. When maneuvering the mat, it doesn’t brittle in pieces.

I will disclose two similar but different processes:

### First Process: Sargasso Mat Process Simultaneously Compressing and Drying

The following are some simple steps to produce Sargasso mats.
a. collecting pelagic Sargasso,
b. arranging uniformly said Sargasso on top of a hard surface area
c. simultaneously storing, compressing with a pressure of less than three PSI and drying said Sargasso, forming a mat, whereby, during the drying process regardless of the loss of water and decrease in the height of said mat the weight forces the Sargasso pieces to interlock and bond with other pieces creating a mat.

### A. Collecting Sargasso

When and where the pelagic Sargasso is collected makes a big difference in the quality of the mat.

Type of Sargasso used in the mat formation

Considering the kind of Sargasso used during the mat formation, trials were made comparing all different samples.

### 1. Sun-Dried Sargasso

There are days when some Sargasso masses are tossed and scattered in the beaches and the sun intensity is enough to dry it in short time. This kind of Sargasso will be referred as sun-dried Sargasso. This Sargasso already lost its water, has all the sulfur content and the fiber’s integrity. However, it is already dried and rigid. It will not flatten easily when compressed. It does not adapt to the mold and neither interlock with other Sargasso masses. Using this Sargasso will produce a mat without cohesion letting the air to go through. This Sargasso is not recommended for this process.

### 2. Degraded Sargasso

Shortly after Sargasso floods the beaches, it starts to smell signaling the start of decomposing. Fresh Sargasso tossed during the night and collected during the next day is stored in a container and three weeks later had converted in a mass similar to compost.

Trials were made creating mats using this compost Sargasso. However, after dried, the mat quality was not proper, the mat flatted, cracked, fell apart easily, and crumbled. So, degraded Sargasso does not create a proper mat.

### 3. Fresh Sargasso With and Without Sand

Sargasso in a sunny day at the beach starts to smell in less than twenty-four hours. That smell are Sulphur compounds in the air that the Sargasso is losing. The future mats will have less defenses against mold. The fresher the Sargasso, the better of its fiber’s integrity. It is better to use fresh Sargasso that has been in the water in the last 24 hours. Fresh Sargasso could be with or without sand, both have its pros and cons.

### 3.A. Fresh Sargasso Without Sand

This is the Sargasso that never reached the beach and was collected from the seawater. It is also the fresh Sargasso collected from the beach that has sand attached but has been washed. This is done by submerging the Sargasso in fresh water or sea water, and stirring it, so the sand is detached from the Sargasso by gravity forces.

This fresh Sargasso also can be submerged one day in Sodium chloride saturated solution. The Sargasso detaches the sand and also absorbs the salt that will inhibits the bacteria grow. This stops the degradation process and keep the integrity of the fibers during the drying process. It will also produce a product with extended life span.

Sargasso without sand produces lighter mats but it takes longer to dry because at the starting point of the process the Sargasso has been totally wet.

### 3.B Fresh Sargasso With Sand

The fresh Sargasso with sand that is collected from the beach is cleaned by shaking its masses on top of a sieve and a blower. This Sargasso still has some sand attached, so I call it Sargasso with sand. It is easier to dry because before collecting it, has been in the beach under the sun and the drying process has already begun. Only the bottom of this Sargasso mass has sand attached. During collection, it is convenient to not to flip it over the sand, so it doesn’t get more sand. After the mat is formed and dried, when handling the mat, a lot of the dried sand now detached from the Sargasso pours out of the mat. Still the final product has more sand and it is heavier. The presence of sand does not make it a worst insulator, sand is a good insulator and fire resistant.

There is not significative difference with insulating properties between mats made with fresh Sargasso with sand and without sand. The first is sturdier while the second is fluffier. Still when wet, the weight of mat of the Sargasso with sand was ten percent heavier than Sargasso without sand and after drying them, that difference increased. This is not necessarily a rule but the fluffy one is more recommended to use insulating roofs and the other one for insulating walls.

### B. Arranging Said Sargasso Uniformly on Top of a Hard Surface Area

Placing the Sargasso on top of a hard surface evenly, uniformly and with the proper amount. At least six volumes of fresh Sargasso are needed to produce one volume of dried Sargasso mat. There is not a standard size, thickness, or weight of the mat. It seems easier to produce thinner mats and use them later together to create a thicker panel. If the Sargasso has any foreign object such as plastic bottles, branches, mangrove seeds, etc., it should be removed.

### C. Simultaneously Storing, Compressing With a Pressure of Less Than Three PSI and Drying Said Sargasso, Forming a Mat, Whereby, During the Drying Process Regardless of the Loss of Water and Decrease in the Height of Said Mat the Weight Forces the Sargasso Pieces to Interlock and Bond With Other Pieces Creating a Mat

Sargasso mats need to be compressed and dried at the same time. If Sargasso is dried and not compressed the mat does not form, the Sargasso parts don’t interlock and don’t bond. Without enough weight, there would be a lot of space between the Sargasso fibers and the hot air will be able to circulate, reducing the thermal insulation properties.

The drying temperatures shouldn’t be superior to eighty degrees Centigrade. The mats are dried until its relative humidity (RH) is less than ten percent superior of the surrounding relative humidity. Fans and heaters accelerate the process and during the drying process a weight is applied.

Eighty percent of the weight of the fresh Sargasso is water. Once the Sargasso is out of the sea, this humidity provides a great environment for bacteria to grow. Once that the mat dries to a humidity of forty percent RH, the degradation process stops. In South Florida with humid summers, normal winds were able to dry the mat in less than two months. However, dry, hot, and windy weather is the best.

When producing a mat of hemp or choir the normal pressures used are one hundred (100) to one thousand (1000) PSI. Surprisingly Sargasso compressed at pressures less than zero point zero one (0.01) PSI formed aerated mats. At zero point zero five (0.05) PSI created good thermal barriers. Around zero point one five (0.15) PSI the mats formed presented the best insulation properties.

Many molds with the same initial volume of Sargasso were used during trials, but different weights were applied. When heavier weights were used, the resultant mats were thinner. When comparing different Sargasso mats the success of the thermal barrier was more related to the thickness of the mat. Moreover, at simple facilities is hard to provide a heavy weight to compress every mat. In the Sargasso trials, the use of more than three (3) PSI produced more compacted mats. But mats made with the same initial volume and lesser pressure, not so compacted, were thicker and better thermal barriers. The use of more pressure will produce more solid mats though. The weight chosen will be according to the final product wanted, but these mats are formed between a range of 0.01 and 3 PSI. Still each one of the Sargasso mats produced in the trials were better insulator than fiberglass.

Sargasso floods many distant beaches that have different resources. During the mat production, the process is the same as stated above, however, the formation mat process adapts to the local resources. One practical small processing plant at least needs trays, a weight, aeration, and a roof.

The following is a simple assembly of trays and guidelines how to produce the mats:
Process of Horizontal Drying in multi-trays:
Sargasso floods beaches in an extended longitudinal line of islands and continental shores so it is convenient to have many separated small processing plants. Sargasso needs to be dried, compressed and protected from the rain.

A separating tray is a 3 D rigid wired tray that consists in an assembly of two rigid metallic flat grids, upper and lower, separated by transversal crossbars made also of a metallic grid that are tied or welded to the other two upper and lower grids. The grid’s gauge varies according to the amounts of the Sargasso mats to be dried and to their thickness.

For these trials, the upper and lower metallic flats grids were done using grids of 19-Gauge and the mesh size of half inch. They were framed parallel and separated two inches by the transversal crossbars made of a 14-Gauge welded wire with a mesh size of 2 inches × 4 inches. The meshed assembly was tied using rebar tie wire, to create one separating tray.

When placing Sargasso on top of the trays it is important that each seaweed gets extended. Some seaweed plants are longer than a yard and if the Sargasso plants are placed having a globular shape, when dried, the formed mat has weak points. Because one plant interlocks with itself but not other plants. At least six volumes of Sargasso are needed to produce one volume of a dried Sargasso mat. The Sargasso has to be distributed evenly over the mesh and compressed against the borders and corners. The length and width of the fresh Sargasso mat has to be longer than the final product desired because, after drying, the mat shrinks in height but also in length and width.

The Sargasso mats are placed on top of each separating tray and later the separating trays are piled one on top of the other. A weight is applied over the upper tray and all of them are covered under a roof. This tray system provides the weight and ventilation needed. As the mats are drying and the weight keeps compressing them, the height of each mat is reduced. During the process and checking the humidity, a forklift can be used to carry and move the wet Sargasso mats. The advantage of this system is that one roof and one weight cover many trays that are drying at the same time.

Mats thicker than 3 inches were hard to dry with just wind. A mat one inch in height is a standard guide.

The size of the metallic mesh of the tray will decide how smooth is the surface of the mat. Meshes with half inch size produce smoother surfaces. Meshes of two or three inches in size produce tufted surfaces. If a mat is going to be glued against another surface, is important that has a smooth surface. Sometimes the goal is to produce mats with tufted surfaces. The tufted spots separate one mat from the other creating an extra layer of air separating them. This is good for thermal and sound absorber purposes.

When drying Sargasso mats in horizontal trays, spacing the mats two inches apart allows the air to flow and dry them.

In the mat formation, the rain is always avoided. As stated above, piles of fresh masses of Sargasso have so high humidity that create an environment where bacteria blooms degrading the Sargasso. However, when Sargasso was disposed in thin meshed trays and air circulates, the degradation process slows down and stops. The mat height, the temperature and the wind strength will determine how long it will take to dry the mat.

### Sargasso Mats

Sargasso mats are no standard mats. Nowadays all thermal barriers used in US in construction are synthetic. Outside US, hemp thermal barriers are gaining momentum. John Ehrisman in his “Study on the processing characteristics and reinforcing potential of natural fibers” shows that the process of creating a fiber mat is not an easy task. There are thousands type of vegetal plants but just a few are used as fibers in the industry. For the nonwoven mats, the manufacturing process is high-tech. There are many factors to consider when producing a mat: selection of the fibers, its uniformity, preprocessing the fibers walls, the carding process of placing the fibers in the same direction the selection of the bonding agent to give the mat cohesion. The process is completed in high-tech processing plants with a compression of 100 to 1000 PSI and fixed temperature and time.

My method of compressing fresh Sargasso is a totally different process. It is simpler and uses the entire seaweed. Its simplicity is due to the characteristics of the Sargasso and many trials and errors. The characteristics and properties of the Sargasso described above allow to use low pressures of PSI of 0.2 instead of hundreds and thousands and to dry the mat with air. The advantages are not just the simplicity of the process, but since all the small parts accommodate inside the mat, there is almost no empty space between the Sargasso pieces creating an airtight insulation barrier. It is not what one somebody familiar with producing mats would think when creating them. Surely a Sargasso mat can be created using a more complex process, but its simplicity makes the process available to all beaches flooded with Sargasso that otherwise would rot in its place.

This process can be accelerated if the Sargasso is first mechanically flattened by heavy compression and later proceed with the step of “simultaneously storing, compressing with a pressure of less than three PSI and drying”. The mechanically flattened can be done by a manually baler machine a roller compactor or any machine that is fed with Sargasso and the machine is able to compress it.

### Second Process. Sargasso Sheet Process of Mechanically Flattening It Against a Hard Surface

The production of a sheet of paper or a sheet of plywood is a high-tech process. There are a lot of preconditioning steps to prepare the fiber before using it in the sheet and the addition of a bonding agent is a must.

In this Sargasso sheet process, the Sargasso masses are heavily compressed, producing a thin sheet that is dried by the sun and air in place. All the Sargasso properties mentioned above allow to create a uniform sheet just by flattening it using a mechanical compression. The goal is to transform the perishable fresh Sargasso in thin sheets that are durable, transportable and can be used in many industries.

A process of making Sargasso sheet consisting:
a. collecting pelagic Sargasso,
b. arranging uniformly the Sargasso on top of a hard surface area
c. flattening mechanically against a hard surface forming said Sargasso sheet
d. drying in less than three days
e. collecting said Sargasso sheet.

The two first steps, “a & b” are the same steps explained in the previous process. As stated above the fresh Sargasso can be immersed in sodium chloride saturated solution. During the immersion the degradation process stops. So according to the weather, the fresh Sargasso collected can be accumulated in ponds with said saturated solutions and later used in drier weather.

The hard surfaces are preferably clean places such as road, parking areas, patios. If Sargasso is placed on top of soil or sand, the Sargasso will get attached with dirt. Sargasso is placed over in the designated areas and all the surface has to be totally covered with Sargasso. The amount of Sargasso will give the thickness of the sheet. The goal is to produce sheets thinner than one centimeter.

Step “c” consists in “Flattening mechanically by compressing the Sargasso against a hard surface”, the Sargasso pieces are compressed against a hard surface in order to bond with each other in one step and expose the moisture to the outside surfaces and creates a sheet to dry.

To produce a standard sheet of one centimeter of height the area has to be covered with a volume of Sargasso between five and ten centimeter high. Once it is properly distributed, a roller compactor compresses it. If there is any foreign object such as plastic, branches etc., it should be removed. It is necessary to check that there are not empty spots on the sheet. If so, more Sargasso is added and compressed again.

Knowing the local weather forecast, it is possible to load trucks with Sargasso and distribute it in vast areas. It is better to do it uniformly in individual sheets slightly separated of others. A couple of days later the Sargasso sheets are dried and are collected with the help of a solid rigid thin sheet.

### Decentralized Process

There are many factors, however, that guide this activity to be decentralized, at least until the Sargasso is dried and molded. Since Sargasso is eighty percent water, to ship it to a processing plant it is unreasonable. It is better to dry it locally using the heat of the tropics. Otherwise, besides the weight to carry all that humid mass, by the time the Sargasso reaches a distant high technology processing plant, the fibers are degraded. For economic reasons, beaches farther than twenty miles away from a high-tech processing plant should process the Sargasso locally.

When one industry needs a product made of Sargasso with a specific size and shape, decentralized plants instead of using flat horizonal separating trays, can use preformed trays with that shape for such part.

### Benefits to the Environment

When Sargasso is collected and kept inside a house as insulator, all the Carbone and other minerals are sequestered from the environment, reducing global warming. Moreover, the amount of microplastics in our oceans is enormous. These huge extensions of Sargasso masses coming to the shores come attached with all the plastic, from microplastic to plastic bottles. Big objects that change the properties of the sheets and mats should be removed. But many tiny pieces will stay in the mats. This activity it acts as a big filter of the Atlantic Ocean.

### Further Processing Mats at High Technology Plant

The mats are rigid when they have a relative humidity (RH) of ten. However, when they have a relative humidity of around 35, the Sargassos are stable, they already had shrunken to its final size, and they are more moldable. It is convenient to use the mat at this stage if it is going to be rolled, folded, glued, sewed, perforated, etc.

The following are different processes that a standard mat can be further processed and create new products. Some are more likely to happen in a central high-tech process plant, some others can be done in decentralized low-tech plants. The Sargasso mat and Sargasso sheets are the unit of thermal barrier. At a high technology plant, the Sargasso sheets and mats produced in low-tech plants can be further processed.

Standardizing mats

1. to be cut in different sizes and trim them in standard sizes.

2. Create a multi-layer panel.

Many Sargasso sheets and mats are used together creating a multi-layer panel. The group is warmed up at 70 C and wrapped in a plastic film. The heat will make the plastic adhere to the Sargasso creating a panel with an extra barrier against humidity. The heat will sterilize the Sargasso extending the life of the panel.

### 3. Fold, Cut Sew and Glue

The mat is cut in pieces or folded to make other product by assembling, sewing or gluing the pieces.

### 4. Adding Additives and Building Materials

There are many materials already utilized in construction that can be used together with the Sargasso sheets and mats, creating new building materials. Just as an example without limiting the scope, the Sargasso sheets and mats irregular surfaces can be superficially infiltrated with other building materials such as stucco, polyurethane, a sand concrete mix, asphalt, silicone, painting. In this way one or more Sargasso sheets and mats, are surrounded by the building material. Sargasso panels can be glued to plywood to use as plywood with insulation.

### 5. Soundproof- Sound Diffuser- Sound-Absorption- Humidity Absorption Panels

For a panel to be soundproof of external noises of the house, it depends on its air tightness. As the Sargasso panels are thermal barriers at the same time are soundproof. They are also great sound absorbers of the internal noises of a room so there is no eco. The sound absorbing quality depends on the porosity of the material. Sargasso panels are very porous.

When producing sound absorber panels, it is convenient to use special separating mesh size between two and three inches. When Sargasso is compressed against these meshes, part of it protrudes through the mesh. The panels will have the two faces having tufted spots. Once the panel is installed, the rear face will be separated slightly from the wall by the tufted spots. The tufted spots from the frontal face of the panel, will reflect the sound in different directions and avoid the eco. This surface’s irregularity is what makes the panels a good sound diffuser.

The Sargasso panels are installed against the existing walls. When producing the Sargasso mats, it is convenient to wash the fresh Sargasso in sodium chloride saturated solution. Sargasso will absorb the salt. The salinity of the Sargasso will extend the life span of the panel. It will also make the panel hygroscopic absorbing the humidity of the room and retain it in the panel that has high Sulphur content and high salinity preventing the mold and bacteria replication. Mold can occur in houses in just one hot season with bad ventilation, producing health issues and costly repairs. These panels will absorb and retain the humidity avoiding mold and bacteria growth.

### 6. Disposable Air Filters

Air filters are made now by a porous filter sheet. They filter particles according to the sizes of the sheet porous. They are two dimensions filters, each side of the sheet.

The Sargasso used in the filters is washed in saturated sodium chloride solution. They become hygroscopic and provide a 3 D frame made of tiny pieces of humid adhesive Sargasso. When the air returns to the AC unit is filtrated by this wet sponge made of Sargasso.

These mats are created with lower pressure. Two or more dried mats are sewed together with loose knots providing cohesion to the mat and forming aerated mats.

The amount of Sargasso used is less than five volumes of Sargasso per unit of dried mat. And the compression needed is less than zero point zero seven 0.07 PSI. The mat is cut into smaller pieces according to standard sizes of air filters. How freely the air travels through the filter and what kind of particles retains is determined by the compression pressure used during the drying. First the corners are cut, and resins are added to its borders. Then the borders are folded and compressed until they dry creating a solid frame to the air filter.

Air pollution is the biggest environmental threat to public health. Big particles fall to the floor, but many small particles stay in the air. Salty Sargasso mats act as big sponges that absorb humidity, fumes, condensation particles, dust, bacteria, virus, and spores from indoors, hospitals, and workplaces. Sargasso per se has many chemical compounds that does not allow the pathogens to replicate.

### 7. Cushioning

Its puffed consistency allows the mat to absorb the shock, the mat still wet is cut in pieces are placed automatically on top of a mold and using compression molding techniques create a packaging mold for different products, standard shipping envelopes, padded chairs, or other uses.

### 8. Sargasso Mat as a Material to Produce Objects

Sargasso is moldable when still fresh. When forming the mat, the space between the trays or molds and the weight will produce a mat with a particular shape. Its appearance is rustic and exotic. Sargasso mat can be produced in particular trays-molds with different shapes, fruit basket, hats, basketry, tapestry and any other existing object made of other material.

### Using the Sargasso Mats at Building Sites

### Walls

When building a traditional wall, one or more Sargasso mats are fixed in the studs. Sargasso mats are more rigid than fiberglass batts but still compressible using more pressure. Although heavier than fiberglass batts, its rigidity makes them stay in place against the wood and create an airtight closure. Additionally, polyurethane foam can be applied to the interior face of the mat to create a humidity barrier and more insulation.

When building the house walls, the Sargasso mats can be fixed to the wooden frame of the house and use them as a lath and spray it with stucco or with a mix of cement, water, and sand. This process can be repeated to create a thick wall.

### Roof

### Sargasso Panels on a Roof

Sargasso mats can be used while building a roof. Many thin Sargasso mats or sheets are placed on top of the roof plywood. The sunny side of the house can have more mats than the rest of the house. After the mats are placed, they are fixed using longer nails or screws and covered with any regular roofing system like shingles, polyurethane spray, silicone painting, metallic panels, roof tiles.

Sargasso mats surrounded by a plastic sheet can be used inside the attic of the house placing them in the studs. Upon installation, the mat’s rigidity will get it stuck between the wooden beams avoiding that its weight lean on the ceiling.

### Conclusion and Advantages

1. Sargasso per se is not a thermal barrier and it does not become naturally a mat. Sargasso at the beach when isolated dries up and becomes rigid or when it floods and piles up, starts decomposing. Only when Sargasso is compressed and dried in specific conditions, it becomes a mat. Moreover, a mat can be made with other plants other than Sargasso but not all the plant mats are good thermal barriers as Sargasso.

2. There are thousand varieties of plants but just a few are used as fibers like cotton, hemp, linen, coir, cellulose. Those fibers need a long and high-tech process in order to be used. With the Sargasso mats however, the entire plant is used and placed with low pressure in molds without any other process. Then it is compressed and dried in a mold, forming a mat. This process is unexpected for someone familiar with the art of creating mats.

3. The Sargasso mat is a better insulator barrier than fiberglass batt, the most used thermal barrier. Fiberglass uses a lot of energy, and it is not eco-friendly. Sargasso mats use mostly sun energy, they are eco-friendly and for recycling Sargasso can be used as mulch.

4. One of the biggest obstacles of using Sargasso in the industry was shipping huge volumes of Sargasso with a lot of humidity and in a timely manner because its wet fibers rot fast. However, the process of drying and compressing Sargasso in local low-tech plants allows to reduce volume and weight at least six times and to create a lasting product.

5. Also, Sargasso mats can be produced and used in distant beaches generating their own materials to insulate their houses.

6. The process sequesters Carbone from the seawaters and hide it inside houses for many, many years.

7. In beaches with tourism, Sargasso is a nuisance and expensive for the cities to keep its beaches clean. This activity will help them to reduce expenses.

8. Wood has lignin and cellulose that burns well and release heat. Sargasso does not have any of those and has a lot of ashes content that makes it hard to burn and also a low burn value, avoiding home fires.

9. Sargasso has many Sulphur compounds that prevent mold formation.

10. The activity will bring jobs to low-income shore communities.

11. When the Sargasso masses have an economic value, it will make sense to farm Sargasso an activity that would purify the oceans.

Although the description above contains many specifications, these should not be construed as limiting the scope of the embodiment, but as merely providing illustrations of some of several shapes, purposes and process steps to produce Sargasso sheets and mats. There is not a unique standard size, height, weight, etc. Just as example most of these activities happens outdoors. There is no controlled environment of temperature, winds, humidity so all the specifications are guidelines but not absolute numbers.

I claim:

1. A mat made of compressed and dried fresh pelagic Sargasso wherein all the seaweed pieces forming said mat are tangled, interlocked, and bonded.

2. The mat made of compressed and dried fresh pelagic Sargasso of claim 1 wherein between said pieces there are connected spaces that allows the air to flow and the mat is used as air filter and shock absorber.

3. The mat made of compressed and dried fresh pelagic Sargasso of claim 1 wherein the mat has the shape of objects with useful purpose such as fruit basket, hats, basketry, tapestry, an any other existing object made of other material.

4. The mat of claim 1 wherein said Sargasso is salty and absorbs humidity, dust, fumes, bacteria, virus, spores from the room.

5. The mat made of compressed and dried fresh pelagic Sargasso of claim 1 wherein said mat is highly porous and it is used as a sound absorber and where the surface of said mat is irregular whereby the sound reflects in the mat in different directions dispersing the sound and diffusing it and avoiding the eco.

6. The mat made of compressed and dried fresh pelagic Sargasso of claim 1 wherein between said pieces there is no space for the air to flow so said mat is used as a thermal barrier and as a sound barrier.

7. The mat made of compressed and dried fresh pelagic Sargasso of claim 6 that is used together with another Sargasso mat creating a multi-layer thicker mat with more insulating properties.

8. The mat made of compressed and dried fresh pelagic Sargasso of claim 6 that after made is surrounded by other building material such as a plastic film, polyurethane, stucco, asphalt, silicone, painting, concrete mix.

9. A process of making Sargasso mats comprising:
(a) collecting pelagic Sargasso,
(b) arranging uniformly the Sargasso on top of a hard surface area,
(c) simultaneously storing, compressing it with a weight and drying said Sargasso until a mat is formed
whereby, during the drying process regardless of the loss of water and decrease in height of said mat, the weight forces the Sargasso pieces to interlock and bond with other pieces creating a mat.

10. The process of claim 9 further comprising washing said collected Sargasso in fresh water, sea water or saturated salt solution.

11. The process of claim 9 wherein the weight provides a pressure to the mat between zero point zero one and three PSI.

12. The process of claim 11 wherein said compression is high enough to produce an airtight mat whereby said mat is used as a thermal insulation and sound barrier.

13. The process of claim 11 wherein said compression produces aerated mats whereby said mats are used as an air filter and shock absorber.

14. The process of claim 11 wherein the drying of the mat is done by the wind.

15. The process of claim 11 wherein the Sargasso is stored, dried and compressed simultaneously in horizontal trays, one on top of each other and spaced by separating trays, allowing air circulation and on top of the upper tray a weight is applied, and a roof is provided consequently all the trays below receive the compression of the weight and the protection from the rain, whereby regardless the location of the beach flooded with Sargasso, said Sargasso can be processed and used.

16. The process of claim 11 wherein after step “c” arranging uniformly the Sargasso, and before step “d” “simultaneously storing, compressing” said process further comprises the step of mechanically flattening said Sargasso against a hard surface, whereby the mat process formation is accelerated.

17. A process of making Sargasso sheets comprising:
(a) collecting pelagic Sargasso,
(b) arranging uniformly the Sargasso on top of a hard surface area,
(c) flattening mechanically against a hard surface forming said Sargasso sheet,
(d) drying in less than three days,
(e) collecting said Sargasso sheet.

18. The process of making Sargasso sheets of claim 17 wherein said sheets are thinner than one centimeter.
